(19) United States
(12) Patent Application Publication
(10) Pub. No.: US 2007/0214180 A1
(43) Pub. Date: Sep. 13, 2007

(54) SOCIAL NETWORK APPLICATION FOR PROCESSING IMAGE OR VIDEO DATA FROM WIRELESS DEVICES OF USERS AND METHODS OF OPERATION

(76) Inventor: C.S. Lee Crawford, Frisco, TX (US)

Correspondence Address: C.S. LEE CRAWFORD, 12132 TERRAZZO LANE, FRISCO, TX, 75035, US

(21) Appl. No.: 11/747,286

(22) Filed: May 11, 2007

Related U.S. Application Data
(63) Continuation-in-part of application No. 11/623,832, filed on Jan. 17, 2007.
Application No. 11/623,832 is a continuation-in-part of application No. 11/559,438, filed on Nov. 14, 2006.
(60) Provisional application No. 60/736,252, filed on Nov. 14, 2005.
(60) Provisional application No. 60/759,303, filed on Jan. 17, 2006.
(60) Provisional application No. 60/773,852, filed on Feb. 16, 2006.
(60) Provisional application No. 60/759,303, filed on Jan. 17, 2006.
(60) Provisional application No. 60/773,852, filed on Feb. 16, 2006.

(51) Int. Cl. G06F 7/00

(52) U.S. Cl. 707/104.1

(57) ABSTRACT

In one embodiment, a method for operating a social network application, comprises: capturing an image or video using a wireless device by a user of the social network application; communicating the image or video from the wireless device of the user to a social network application server; storing the image or video by the social network application server; identifying a user account by the social network application server in response to communication of the image or video; and modifying data, by the social network application server, associated with the account of the user to automatically post the image or video to a web page of the user to make the image or video available for viewing by other users of the social network application.

### RELATED APPLICATIONS

This application is a continuation-in-part of U.S. patent application Ser. No. 11/623,832, filed Jan. 17, 2007, which is a continuation-in-part of U.S. patent application Ser. No. 11/559,438, filed Nov. 14, 2006 (which claims the benefit of U.S. Provisional Application Ser. No. 60/736,252, filed Nov. 14, 2005, U.S. Provisional Patent Application Ser. No. 60/759,303, filed Jan. 17, 2006 and U.S. Provisional Patent Application Ser. No. 60/773,852, filed Feb. 16, 2006); U.S. patent application Ser. No. 11/623,832 also claims the benefit of U.S. Provisional Patent Application Ser. No. 60/759,303, filed Jan. 17, 2006 and U.S. Provisional Patent Application Ser. No. 60/773,852, filed Feb. 16, 2006.

### BACKGROUND

Location based services refer generally to services that provide information to a user in relation to the location of the user. At the present time, location based services are relatively pedestrian in nature and provide relatively simple information. An example of a known location based service is a “weather” service in which the user's zip code is provided to the service (e.g., through a conventional HTML webpage, a WAP or other cellular phone interface, etc.) through a network and the service responds by communicating the current weather conditions and the forecast for several days. Other known location based services provide “social” applications such as allowing users to determine each other's locations, receive notification when a friend comes within a predetermined distance, and similar operations. Another type of location based services are generally referred to as “McDonalds finders” that provide search results in a map form (e.g., searching for specific locations of restaurants/stores within a given distance of the user). Other location based services have proposed delivering various types of “advertising” (e.g., when a user arrives at an airport, various ads can be delivered to the user's cellular phone). However, such advertising location based services are quite simplistic and do not possess any appreciable intelligence for selecting advertisements beyond the location of the user.

Social network applications commonly refer to applications that facilitate interaction of individuals through various websites or other Internet-based distribution of content. Originally, the concept of a social network originated within the field of sociology as method of modeling social interactions or relationships. Within such modeling, individuals, groups, or organizations are represented as nodes within a social network and the relationships between the “nodes” are represented as links between the nodes thereby forming a “network.”

Social network applications have knowingly or unknowningly utilized such concepts to facilitate interaction between individuals via the Internet. In most social network applications, a specific user can create an account and provide various types of content specific to the individual, such as pictures of the individual, their friends, their family, etc., personal information in text form, favorite music or videos, etc. The content is then made available to other users of the social network application (sometimes limited upon restrictions defined by the respective user). For example, one or more web pages may be defined for each user of the social network application that can be viewed by other users of the social network application. Also, social network applications typically allow a user to define a set of “friends,” “contacts,” or “members” with whom the respective user wishes to repeatedly communicate. Users of a social network application may post comments or other content to portions of each other's web pages.

For the purpose of this application, a social network application refers to any application in which users are permitted to create or define accounts in which the users can make personalized content available via the Internet for viewing by other users of the social network application and, in which, users can define, allow, or create contacts or friends within the social network application in which repeated interaction is intended to occur through the social network application.

### SUMMARY

In one embodiment, a method for operating a social network application, comprises: capturing an image or video using a wireless device by a user of the social network application; communicating the image or video from the wireless device of the user to a social network application server; storing the image or video by the social network application server; identifying a user account by the social network application server in response to communication of the image or video; and modifying data, by the social network application server, associated with the account of the user to automatically post the image or video to a web page of the user to make the image or video available for viewing by other users of the social network application.

The foregoing has outlined rather broadly certain features and/or technical advantages in order that the detailed description that follows may be better understood. Additional features and/or advantages will be described hereinafter which form the subject of the claims. It should be appreciated by those skilled in the art that the conception and specific embodiment disclosed may be readily utilized as a basis for modifying or designing other structures for carrying out the same purposes. It should also be realized by those skilled in the art that such equivalent constructions do not depart from the spirit and scope of the appended claims. The novel features, both as to organization and method of operation, together with further objects and advantages will be better understood from the following description when considered in connection with the accompanying figures. It is to be expressly understood, however, that each of the figures is provided for the purpose of illustration and description only and is not intended as a definition of the limits of the appended claims.

### BRIEF DESCRIPTION OF THE DRAWINGS

FIG. 1 depicts a system for implementing a social network application in which image and/or video data can be communicated between “friends” using a location based service scheme or otherwise according to one representative embodiment.

FIG. 2 depicts a flowchart for creating and/or managing a social network application account according to one representative embodiment.

FIG. 3 depicts a flowchart for communicating image and/or video data between users of a social network application according to one representative embodiment.

FIG. 4 depicts a flowchart for communicating image and/or video data between users of a social network application according to another representative embodiment.

### DETAILED DESCRIPTION

Some representative embodiments are directed to a social network application that permits users of the application to communicate image and/or video data using location based service functionality. In some embodiments, users of the social network upload image and/or video data to their accounts with the social network application using camera-capable wireless devices (e.g., digital camera enabled cellular phones). In preferred embodiments, location information is associated with the images or videos when transferred to the image/video server. Certain images may be communicated to all or selected members of each user's group of “friends” or “contacts” according to a “location based service” scheme. For example, suppose a first user takes a picture at a nightclub and transfers the picture to the image/video server using their camera phone. When other users of the social network who are “friends” of the first user arrive at the nightclub or any suitable location, the other users may receive communication of the image or video via their cell phones. In other embodiments, the image and/or videos are relatively immediately (e.g., within a few minutes) communicated to one or more users who are friends of the first user irrespective of the location of the users.

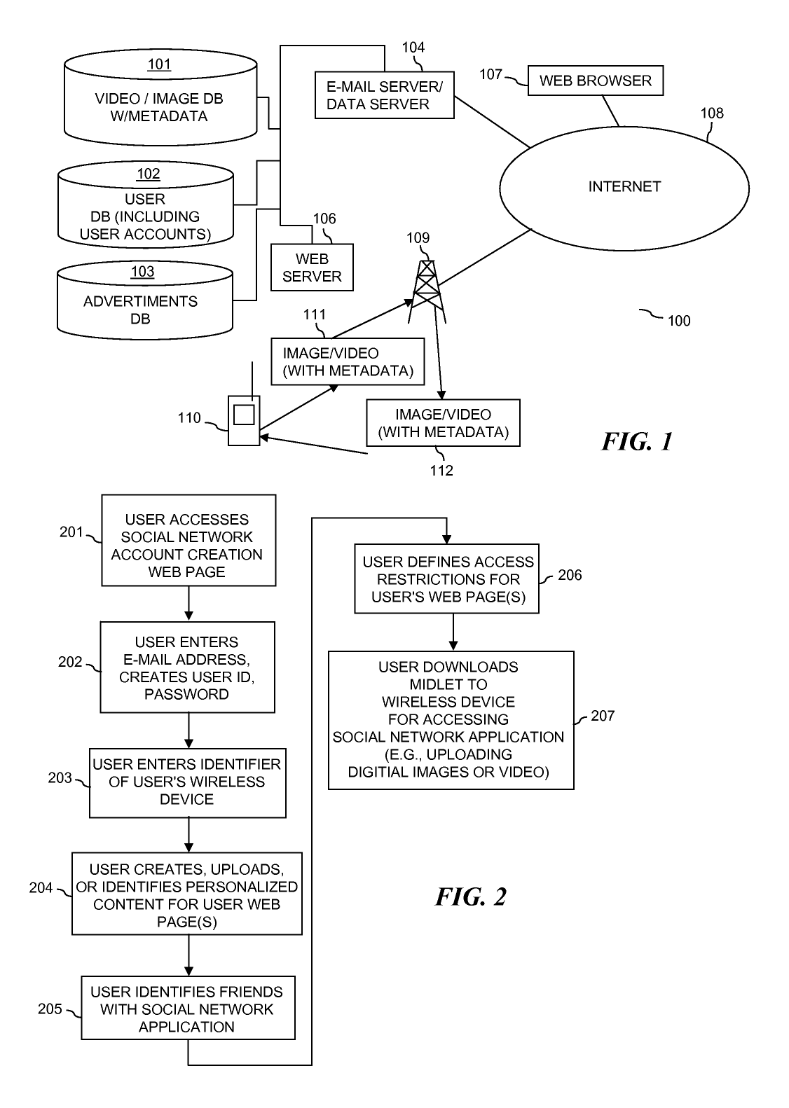

Referring now to the drawing(s), FIG. 1 depicts system 100 for operating a social network according to one representative embodiment. Initially, a user can use their web browser 107 to access a web site served by social network application web server 106 through Internet 108. The user can create an account for sharing personal information, digital content, etc. with other users of the social network application. During creation of the account, the user can define a user ID, password, etc. which can be stored in database (DB) 102. The user can define a web page, upload content, etc. for their personal web page on the social network application, where the appropriate data is stored in DB 102. The user can also allow family members, friends, co-workers, acquaintances, other social network application users, etc. to become “friends” in the social network application as defined by data stored in DB 102.

Preferably, the users can provide appropriate information to facilitate the communication of image and/or video data using wireless devices of the users of the social network application (e.g., a phone number of the wireless device, the e-mail address/user information associated with the user's wireless device, etc.). In one embodiment, a JAVA™ MIDlet is stored on the user's wireless device to facilitate the communication of the image and/or video data. In another embodiment, during the account creation process, the user is provided a registration string and the user e-mails the registration string to a predefined e-mail address associated with the social network application. The user's e-mail information is automatically gathered from the registering user's e-mail. A user token can be optionally defined for inclusion within subsequently communicated image or video messages. Only image or video messages from appropriate e-mail addresses containing suitable user information and/or the user token are accepted for posting to a user's web page(s) or communication to other users.

Database 102 stores identifiers of the user accounts, the friends of each user, content for each user's web page within the social network application, various user information, user identifiers, user passwords, user cellular phone numbers or e-mail addresses, etc. It shall be appreciated that when the present application discusss a database or server, any suitable computing architecture could be employed. For example, the desired functionality could be duplicated using multiple instances of software and multiple platforms. The various software and platforms could also possess a distributed architecture. Also, DB 102 need not be implemented using a strict database application. Any suitable set of software for storing and managing data could be employed.

After creating an account with the social network application, the users of the social network application can begin sharing image or video messages. A user can take a picture or a video at a given location. The user can transfer the image to e-mail server 104 or web server 106 as examples. In some embodiments, a MIDlet, a script, or another suitable program also is stored on the user's cell phone 110 to facilitate the transfer. The MIDlet preferably allows the user to input metadata (e.g., a text description) to be associated with the image and/or video data. Other data could also be associated with the image or video such as audio data.

In some embodiments, depending upon the capabilities of the wireless device, the MIDlet uses the cell phone functionality to determine the approximate location of the user's cell phone 110 (e.g., using the cell phone's 110 assisted GPS (AGPS) functionality), see e.g., the “location API” published for J2ME. In other embodiments (e.g., non-AGPS devices operating in GSM networks), the CELL-ID is obtained (e.g., using the appropriate API call using a PYTHON script on a Symbian OS-based cellular phones) for the purpose of automatically identifying the approximate location of the user's cell phone 110. Depending upon the capability of the wireless device the identifiers of “Wi-Fi” hotspots can be obtained for the purpose of identifying the approximate location of the user's device (i.e., the identifiers are used to perform a look-up of the user location against a database that correlates Wi-Fi identifiers to GPS, addresses, ZIP codes, or other coordinates). In alternative embodiments, a “network-location” service is used to determine the location associated with the user's cell phone 110 upon receipt of the e-mail. In an alternative embodiment, the user can input the location in a user interface of the MIDlet.

Upon receiving/obtaining the information, the MIDlet preferably creates an e-mail or “multi-media message” (MMS) containing the various information (perhaps in encrypted form) with the image as an attachment and communicates the e-mail/MMS 111 using cellular infrastructure 109. In other embodiments, the image and the metadata can be communicated separately. Other communication protocols could be alternatively employed. E-Mail/data server 104 may receive the image and the metadata and stores them in image DB 101. Other users within the social network may subsequently view the image/video and selected metadata via their cellular phones 110, their web browsers 107, their e-mail clients (not shown), etc. The metadata may also identify that the user wishes to immediately transfer the image and data to one or more selected friends within the social network. If so, e-mail/data server 104 preferably communicates the image or video to the other users' cellular phones or wireless devices 110.

When a user transfers an image to the image/video database, one or several advertisements are preferably sent to the user (and/or recipients of the image/video). In preferred embodiments, the location information is used to select one or several advertisements from advertisements DB 103. Additionally, the metadata is also used to select the one or several advertisements from DB 103 (e.g., using keyword matching and/or context analysis using the text description supplied by the given user). By utilizing such information, a more effective selection of advertisements can occur. Multiple advertisements can be communicated to the user at a single time. For example, browser-executable files can be communicated to allow the user to browse through multiple ads. Some of the ads in the browser-executable files can be described in text format and some of the ads can be shown with images. Any suitable format for the advertisements may be employed such as SMS messages, MMS messages, etc.

As previously mentioned, a user can communicate an image or video to one or several other “friends” within the social network application on a substantially immediate basis. Images and metadata can be shared in other ways. Users within the social network can view each other's images using their web browsers 107. Also, if desired, users within the social network could access the images via a browser executing on their cellular phone 110. In some embodiments, a user can communicate their current location (e.g., through manual data entry, through AGPS functionality of their phone, or automatically through a MIDlet) to obtain recently uploaded images or videos associated with “nearby” locations. For example, images or videos from a first user can automatically be communicated to friends of a first user when the friends arrive at locations where the first user had originally taken the images or videos. In preferred embodiments, the communication of image and/or video data is automatic. Specifically, when a user arrives at a given location, a MIDlet on the user's wireless device communicates the location of the wireless device to server 106. Web server 106 uses the location information to determine whether there are any images or videos from friends of the respective user associated with the current location of the user. If so, web server 106 communicates the images and/or videos to the user. For example, the images and/or videos may “pop-up” for presentation to the user when the user arrives at a specific location.

In some embodiments, a users can access one or more webpages (e.g., through a typical web browser or, perhaps, a wireless device-specific browser) to view uploaded images from their friends. The webpages preferably organize the images in multiple ways (e.g., by friend, by location, by types, by metadata descriptors, etc.). The user can navigate through a series of links corresponding to the organization of the images and videos to browse through content of interest. Alternatively, the user can submit a query for content of interest (of friends only and/or of other non-friend users) to receive search results from the database of images, videos, and metadata. Also, advertisements are preferably provided along with the images and videos—whether the user browses through the navigation links or submits a search query.

In some embodiments, when user wireless devices contain more advanced location functionality (e.g., AGPS functionality), a user within the social network may be notified when friends of the user within the social network application are present at the same approximate location for the purpose of allowing the friends to meet each other. For example, suppose a first user of the social network arrives at “Willow Bend” mall. When another user who is a friend of the first user arrives at the mall, the first user can be notified of the arrival of the second user and the second user can be notified of the particular location of the first user (e.g., at store “X”). In one representative embodiment, an image or video message from the other user can be delivered with the notification. Also, the location notification functionality can preferably be “turned” on and off by users of the social network application (if the users do not wish to be located at a particular time). The image or video message can be intended for any friend or specifically addressed for an identified “friend” (i.e., it will only be delivered to the identified friend).

In some embodiments, video or images can be made available for any users within the social network application. For example, when a first user arrives at a location, the user may submit a request to view any recent images or videos uploaded for the user's current location using a MIDlet on the user's wireless device. A number of images or videos from other users (whether friends or not) may then be communicated to the first user. A list of available images or videos can be presented to the first user to permit the first user to select specific content for viewing. Additionally, the first user may submit various search terms to identify images or videos of interest to the first user from all available images or content for the current location of the first user. In one representative embodiments, a user may define various criteria via their account that define the types of videos that the user wishes to receive (whether from friends or otherwise). The social network application will then communicate matching image and/or videos to the user according to the defined criteria as the user goes from location to location.

FIG. 2 depicts a flowchart for creating and/or managing a social network application account according to one representative embodiment. In 201, a user accesses social network account creation web page. In 202, the user enters e-mail address, creates user id, password, in accordance with typical account creation methods. In 203, the user enters an identifier of the user's wireless device (e.g., the telephone number, the ESN/MIN, an e-mail address associated with an account maintained by the service provider of cellular services, etc.). In 204, the user creates, uploads, or identifies personalized content for user web page(s) using typical web methods. In 205, the user identifies friends with social network application. In 206, the user defines access restrictions for user's web page(s). The user can define restrictions that only permit certain users (e.g., only friends, only selected friends, users matching specific (demographic or otherwise) criteria) to view, access, or receive communication of certain types of content. For example, the user may only wish selected friends to receive images and video data via LBS functionality and the social network application will then only communicate such data to those friends.

In 207, the user downloads a MIDlet to wireless device for accessing social network application (e.g., uploading digital images or video). Preferably, the user is given instructions in a web page provided by the social network application during the account creation process how to access the MIDlet. For example, the user is preferably given a URL to enter in the browser of the user's wireless device to obtain the MIDlet and instructions upon how to install the URL on his or her phone. The MIDlet may be personalized for the user to make performing different actions within the social network more efficient such as to communicate with specific friends with the social network. In an alternative embodiment, a MIDlet may be pre-installed on a commercially available cellular phone or other wireless device and the user need only provide his or her account information (e.g., user ID, password, and/or the like) to make the MIDlet functional with regard to the user's account with the social network application.

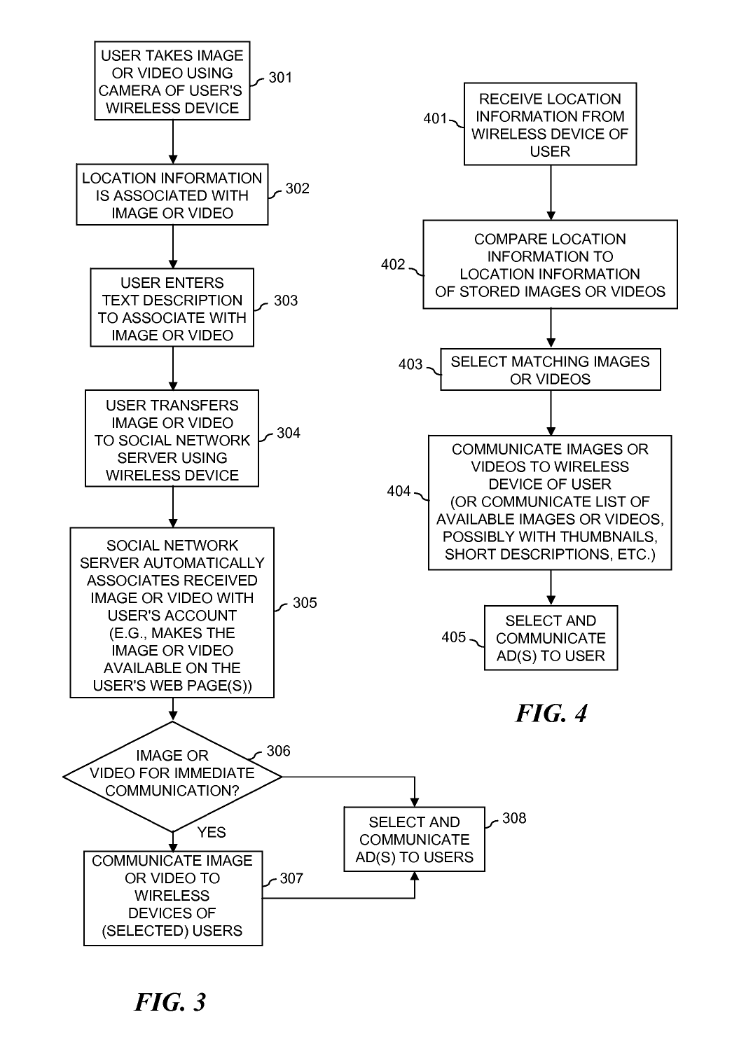

FIG. 3 depicts a flowchart for communicating image and/or video data between users of a social network application according to one representative embodiment. In 301, a user takes an image or video using camera of user's wireless device. In 302, location information is associated with image or video. In 303, the user enters text description to associate with image or video. In 304, the user transfers image or video to social network server using wireless device. This may occur automatically by software on the user's wireless device in some embodiments. In 305, the social network server automatically associates received image or video with the user's account (e.g., makes the image or video available on the user's web page(s)). In 306, a logical determination is made whether the image or video is for immediate communication (e.g., whether the user wishes the image or video to be sent to specific friends of the user). If so, the social network server communicates the image or video to wireless devices of (selected) users (307). In 308, ads are selected and communicated to users.

FIG. 4 depicts a flowchart for communicating image and/or video data between users of a social network application according to another representative embodiment. In 401, a social network server receives location information from a wireless device of a user. In 402, the server compares location information to location information of stored images or videos. The location information may be information that defines where the stored images or videos were originally taken. Alternatively, a user could input location information for association with images or videos independently from where the images or videos were taken. For example, a supervisor may create a video for traveling subordinate employees for viewing by the employees when the employees arrive at a particular location (e.g., a client's office complex). Such location information may be associated with an image or video by entering known GPS coordinates, a street address, or by selecting a region or area on a map interface provided by the social network application. In 403, the server selects matching images or videos based upon the sets of location information. Other information may be used for the matching such as any selection criteria provided by the user (e.g., from certain users, certain friends, keywords for matching in associated text descriptions, etc.). In 404, the social network server communicates images or videos to the wireless device of user. Additionally or alternatively, the social network server may communicate a list of available images or videos, possibly with thumbnails or short descriptions of the available content. In 405, ads are selected and communicated to users by a suitable server.

Representative embodiments can be used for a variety of purposes to facilitate interaction between users of a social network application. For example, a company may implement a social network application to manage employees of the company according to various levels of corporate hierarchies. In accordance with one representative embodiment, the distribution of image and/or videos using location based services for such a social network application permits managers of the company to give specific direction and distribute information to employees when the employees are engaged in activities in the field.

As another example, a “dating” social network application may allow a first user who is seeking to meet new people to leave a video to be distributed to other users of the matching specific criteria for delivery at a specific location where the user is currently located (e.g., at a coffee house, bookstore, nightclub, etc.). Thereby, if any user matching the criteria arrives at the location, the image or video of the first user is automatically delivered to the other users giving the other users notification that the first user is at the location, is seeking to meet new people, and information about the first user.

When implemented in software, the various elements or components of representative embodiments are the code or software segments adapted to perform the respective tasks. Any type of suitable code or software may be utilized from machine code, complied software, interpreted software, browser executable code (e.g., HTML, JAVA script, FLASH code, etc), “JAVA” variants, PYTHON scripts, and/or the like. The program or code segments can be stored in a machine readable medium, such as a processor readable medium, or transmitted by a computer data signal embodied in a carrier wave, or a signal modulated by a carrier, over a transmission medium. The “computer readable medium” may include any medium that can store or transfer information. Examples of the computer readable medium include an electronic circuit, a semiconductor memory device, a ROM, a flash memory, an erasable programmable ROM (EPROM), a floppy diskette, a compact disk CD-ROM, an optical disk, a hard disk, a fiber optic medium, a radio frequency (RF) link, etc. The computer data signal may include any signal that can propagate over a transmission medium such as electronic network channels, optical fibers, air, electromagnetic, RF links, etc. The code segments may be downloaded via computer networks such as the Internet, an intranet, etc.

Although representative embodiments and advantages have been described in detail, it should be understood that various changes, substitutions and alterations can be made herein without departing from the spirit and scope of the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure that processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

Claims:

1. A method for operating a social network application, comprising:
capturing an image or video using a wireless device by a user of the social network application;
communicating the image or video from the wireless device of the user to a social network application server;
storing the image or video by the social network application server;
identifying a user account by the social network application server in response to communication of the image or video; and
modifying data, by the social network application server, associated with the account of the user to automatically post the image or video to a web page of the user to make the image or video available for viewing by other users of the social network application.

2. The method of claim 1 wherein the user enters a text description to accompany the image or video and the social network server posts the text description along with the image or video to a web page of the user.

3. The method of claim 2 further comprising:
communicating ads to one or more users using keyword analysis of a text description associated with an image or video communicated to or from the user.

4. The method of claim 1 further comprising:
in response to receiving communication of the image or video from the wireless device of the user, communicating the image or video to wireless devices of other users of the social network application.

5. The method of claim 4 wherein the other users of the social network application are selected friends of the user within the social network application.

6. A method for operating a location based service (LBS) in conjunction with a social network application, comprising:
receiving digital images or videos from users of the social network application from wireless devices of the users of the social network application;
storing the digital images or videos in accounts associated with respective users of the social network application;
receiving location information indicative of a current location of respective users of the social network application;
comparing the received location information to location information associated with the stored digital images or video to select digital images or video for communication to respective users of the social network application; and
delivering selected images or videos to wireless devices of respective users of the social network application.

7. The method of claim 6 further comprising:
receiving, from a given user of the social network application, identification of friends of the given user within the social network application in conjunction with receiving one or more digital images or videos from the given user; and
immediately communicating one or more corresponding digital images or videos to wireless devices of the identified friends of the given user of the social network application.

8. The method of claim 6 further comprising:
selecting ads for users of the social network application from an ad database using the metadata associated with respective digital images or videos communicating by the users.

9. The method of claim 8 wherein the selecting ads comprises:
performing keyword matching of text descriptions supplied by the users to perform the selecting.

10. A system for operating a social network application, comprising:
first software code executed on one or more wireless devices of users of the social network application, the first software code on each wireless device being operable to communicate image or video from the respective wireless device of the user to a social network application server;
second software code executed on one or more servers, the second software code being operable to: (i) store image or video from wireless devices of users of the social network application; (ii) identify user accounts in response to communication of images or videos; and (iii) modify data associated with the accounts of users of the social network application to automatically post the images or videos to web pages of the users of the social network application to make the images or videos available for viewing by other users of the social network application.

11. The system of claim 10 wherein text descriptions accompany the images or videos and the second software code posts the text description along with the images or videos to web pages of the users.

12. The system of claim 10 wherein the second software code is further operable to communicate ads to one or more users using keyword analysis of text descriptions associated with images or videos communicated to or from the users.

13. The system of claim 10 wherein the second software code is operable to: in response to receiving communication of an image or video from the wireless device of a respective user, communicate the image or video to wireless devices of other users of the social network application.

14. The system of claim 13 wherein the other users of the social network application are selected friends of the user within the social network application.
